(19) United States
(12) Patent Application Publication
(10) Pub. No.: US 2014/0164119 A1
(43) Pub. Date: Jun. 12, 2014

(54) METHOD AND SYSTEM FOR GEOCODING AUTHORIZATIONS AND FINANCIAL TRANSACTION MESSAGES FOR LOCATION-BASED SERVICES

(71) Applicant: MASTERCARD INTERNATIONAL INCORPOTATED, Purchase, NY (US)

(72) Inventors: Sheila NARAYANAN, Ardsley, NY (US); Richard David D'ERIZANS, Pleasantville, NY (US); Christopher Andrew GUINEY, Fenton, MO (US); Maurice David LISCIA, Long Island City, NY (US); Andrew St. John WOODWARD, Old Greenwich, CT (US)

(73) Assignee: MasterCard International Incorpotated, Purchase, NY (US)

(21) Appl. No.: 13/707,274

(22) Filed: Dec. 6, 2012

(51) Int. Cl. G06Q 20/40

(52) U.S. Cl. CPC G06Q 20/40
USPC 705/14.58; 705/44

(57) ABSTRACT

A method for identifying a geographic location of a financial transaction includes: storing, in a merchant database, a plurality of merchant data entries, wherein each merchant data entry includes at least a merchant identifier and a geographic location; receiving, by a receiving device, an authorization request for a financial transaction, wherein the authorization request includes at least a plurality of data elements containing transaction information; identifying, by a processing device, a first data element in the plurality of data elements including a merchant identification; identifying, in the merchant database, a specific merchant data entry, wherein the merchant identifier of the specific merchant data entry corresponds to the merchant identification; transmitting, by a transmitting device, a reply to the authorization request; and transmitting, by the transmitting device, the geographic location included in the specific merchant data entry.

### RELATED APPLICATIONS

This application claims the priority benefit of commonly assigned U.S. Provisional Application No. 61/568,799, filed Dec. 9, 2011, for “Method and System for Geocoding Authorizations and Financial Transaction Messages for Location-Based Services,” by Sheila Narayanan et al., which is herein incorporated by reference in its entirety.

### FIELD

The present disclosure relates to location identification of a financial transaction, specifically identifying the geographic location of a merchant of a financial transaction based on authorization information and utilizing the identified location for location-based services.

### BACKGROUND

In traditional financial transactions involving transaction cards, such as credit cards, a consumer will use the transaction card to purchase products (e.g., goods or services) from a merchant. To process the transaction card, an authorization request is sent from the merchant or their acquiring bank to the transaction card's issuing bank, or to a specified financial payment system processor who processes transactions on behalf of the issuing and acquiring banks.

Authorization requests may include a variety of information that are stored in fields known as data elements, such as in accordance with the International Standard of Organization's ISO 8583 standard. Some of these data elements may include useful information, such as data element 43, which may include the name and a general physical location, such as the city and/or state, of the merchant involved in the financial transaction.

Due to the prevalence of consumers carrying mobile devices, and the emergence of location-based services, consumers, merchants, issuers, and third parties have developed a desire for obtaining an accurate geographic location of financial transactions. In particular, many merchants and manufacturers many have an interest to distribute offers (e.g., deals, coupons, discounts, etc.) to consumers in the area, to entice the consumer to purchase their products or visit their establishments. The distribution of an offer to a consumer in the same area as where they may redeem the offer may result in the consumer visiting the merchant when they otherwise may not have. However, authorization requests do not provide enough detail to establish the geographic location of a consumer when engaged in a transaction.

Thus, there is a need for a technical solution that identifies a geographic location of a financial transaction based on data elements included in the authorization request for the use in providing location-based services to a consumer involved in the transaction.

### SUMMARY

The present disclosure provides a description of a systems and methods for identifying the geographic location of a financial transaction.

A method for identifying a geographic location of a financial transaction includes: storing, in a merchant database, a plurality of merchant data entries, wherein each merchant data entry includes at least a merchant identifier and a geographic location; receiving, by a receiving device, an authorization request for a financial transaction, wherein the authorization request includes at least a plurality of data elements containing transaction information; identifying, by a processing device, a first data element in the plurality of data elements including a merchant identification; identifying, in the merchant database, a specific merchant data entry, wherein the merchant identifier of the specific merchant data entry corresponds to the merchant identification; transmitting, by a transmitting device, a reply to the authorization request; and transmitting, by the transmitting device, the geographic location included in the specific merchant data entry.

Another method for identifying the geographic location of a financial transaction includes: storing, in a merchant database, a plurality of merchant data entries, wherein each merchant data entry includes at least a merchant identifier, a physical location, and a geographic location; receiving, by a receiving device, an authorization request for a financial transaction, wherein the authorization request includes a plurality of data elements containing transaction information; identifying, by a processing device, a first data element in the plurality of data elements including a merchant identification; identifying, by the processing device, a second data element in the plurality of data elements including a physical locator; identifying, in the merchant database, a number of merchant data entries where the included merchant identifier corresponds to the merchant identification of the first data element and the included physical location corresponds to the physical locator of the second data element; and transmitting, by a transmitting device, the geographic location of a single merchant data entry if the number of merchant data entries is one.

A system for identifying a geographic location of a financial transaction includes a merchant database, a receiving device, a processing device, and a transmitting device. The merchant database is configured to store a plurality of merchant data entries, wherein each merchant data entry includes at least a merchant identifier and a geographic location. The receiving device is configured to receive an authorization request for a financial transaction, wherein the authorization request includes at least a plurality of data elements containing transaction information. The processing device is configured to identify a first data element in the plurality of data elements including a merchant identification, and identify a specific merchant data entry, wherein the merchant identifier of the specific merchant data entry corresponds to the merchant identification. The transmitting device is configured to transmit a reply to the authorization request, and transmit the geographic location included in the specific merchant data entry.

Another system for identifying the geographic location of a financial transaction includes a merchant database, a receiving device, a processing device, and a transmitting device. The merchant database is configured to store a plurality of merchant data entries, wherein each merchant data entry includes at least a merchant identifier, a physical location, and a geographic location. The receiving device is configured to receive an authorization request for a financial transaction, wherein the authorization request includes a plurality of data elements containing transaction information. The processing device is configured to: identify a first data element in the plurality of data elements including a merchant identification; identify a second data element in the plurality of data elements including a physical locator; and identify, in the merchant database, a number of merchant data entries where the included merchant identifier corresponds to the merchant identification of the first data element and the included physical location corresponds to the physical locator of the second data element. The transmitting device is configured to transmit the geographic location of a single merchant data entry if the number of merchant data entries is one.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for identifying the geographic location of a financial transaction in accordance with exemplary embodiments.

FIG. 2 is a block diagram illustrating a processing server for use in the system of FIG. 1 in accordance with exemplary embodiments.

FIG. 3 is a block diagram illustrating the merchant database of FIG. 1 in accordance with exemplary embodiments.

FIGS. 4A and 4B are a flow diagram illustrating a method for identifying a geographic location of a financial transaction and providing location-based services in accordance with exemplary embodiments.

FIG. 5 is a block diagram illustrating system architecture of a computer system in accordance with exemplary embodiments.

FIGS. 6 and 7 are flow charts illustrating exemplary methods for identifying the geographic location of a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Identifying a Geographic Location of a Financial Transaction

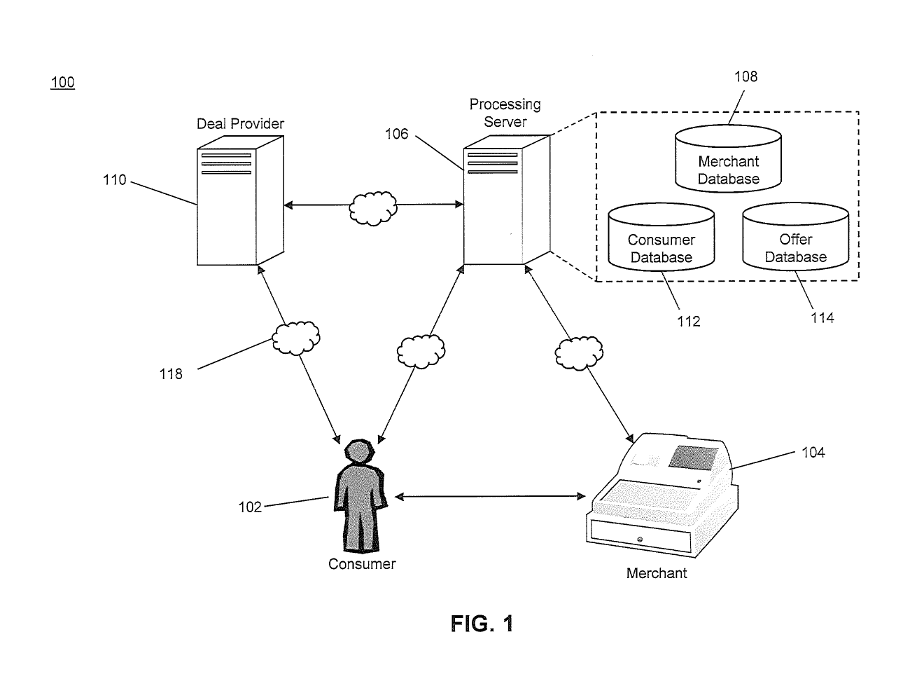

FIG. 1 is a block diagram illustrating a system 100 for identifying the geographic location of a financial transaction and distributing location-based offers to a consumer involved in the financial transaction. The system 100 may include a consumer 102, a merchant 104, a processing server 106, and a deal provider 110. Each of the components may be configured to communicate via a network 118. The network 118 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The consumer 102 may visit the merchant 104 and engage in a financial transaction (e.g., for goods or services). The consumer 102 may use a payment card to fund the transaction, such as a credit card or debit card issued to the consumer 102 by an issuing bank. The merchant 104, or an acquiring bank on behalf of the merchant 104, may process the financial transaction by submitting an authorization request to the processing server 106, which may be a financial transaction processing agency, such as MasterCard®, VISA®, etc. Examples of financial transaction processing systems suitable for use in the methods and systems as disclosed herein may be found in U.S. Patent Publication No. 2011/0047075, entitled “Location Controls on Payment Card Transactions” by Pablo Fourez (filed on Aug. 19, 2009 as U.S. patent application Ser. No. 12/544,009), which is herein incorporated by reference in its entirety.

The authorization request may include data regarding the financial transaction (e.g., transaction information), such as the transaction amount, the time and/or date of the transaction, consumer information, merchant information, payment card information, etc. In one embodiment, the authorization request may be defined by the ISO 8583 standard published by the International Organization for Standardization (ISO). A typical message, such as the authorization request, following the ISO 8583 standard may contain at least three parts: a message type indicator (MTI), one or more bitmaps indicating present data elements, and data elements.

The MTI may be a four digit numeric field that classifies the function of the message. For example, one digit may represent the version of the ISO 8583 standard (e.g., the 1993 or 2003 version), one may represent the message class (e.g., an authorization message or a financial message), one my represent the function of the message (e.g., a request, a response, advice, etc.), and one may represent the origin of the message (e.g., an acquirer, an issuer, the merchant 104, etc.). For example, the MTI of “0100” may represent an authorization request from a point-of-sale (POS) terminal of the merchant 104 for authorization of a payment card purchase.

Bitmaps contained in the authorization request may be transmitted as 8 bytes of binary data, or as 16 hexadecimal characters. In one embodiment, the bitmap may indicate the presence of up to 64 data elements. In other embodiments, additional bitmaps may be contained in the message to indicate the presence of additional data elements. For example, a secondary bitmap and a tertiary bitmap may be contained in the message to indicate the presence of data elements 65 to 128 and 129 to 192, respectively.

Data elements may be individual fields of the authorization request that contain transaction information, which may be used by the processing server 106 to process the financial transaction. The ISO 8583 standard defines usage parameters for each data element from a first data element to a 192^{nd} data element, including a format for data contained in each data element. It will be apparent to persons having skill in the relevant art that only some data elements and not others may be useful for the systems and methods as disclosed herein. For example, data element 43 is defined by the ISO 8583 standard to contain 40 alphabetic, numeric, or special characters identifying the card acceptor (e.g., the merchant 104) name and location. For example, characters 24 to 36 of data element 43 may represent the city in which the financial transaction takes place.

As part of processing the financial transaction, the processing server 106 may analyze the transaction information (e.g., the data elements) included in the authorization request to identify the merchant 104. In one embodiment, the merchant 104 may be identified using a merchant identifier, such as a merchant identification number (MID). In another embodiment, the merchant 104 may be identified using a physical location of the merchant 104, such as the city included in data element 43 if the merchant 104 is the only store with that name in the city. Methods for identifying the merchant 104 are discussed in more detail below.

The processing server 106 may, using a merchant database 108, identify a geographic location for the merchant 104 based on the identification of the merchant 104 and associated geographic locations. The merchant database 108 is discussed in more detail below. The geographic location may be any representation of the geographic location of the merchant 104, such as a latitude and longitude coordinate or a street address. In one embodiment, the processing server 106 may transmit the identified geographic location to the deal provider 110, for providing offers (e.g., deals, coupons, discounts, rewards, etc.) to the consumer 102 based on the identified geographic location. In a further embodiment, the processing server 106 may transmit consumer information included in the authorization request to the deal provider 110 for identification of the consumer 102.

In another embodiment, the consumer 102 may enroll in an offer distribution service with the processing server 106. The consumer 102 may enroll in the service by providing information to the processing server 106 suitable for authenticating the consumer 102 and distributing offers to the consumer 102. Information suitable for authentication and distribution will be apparent to persons having skill in the relevant art, and may include at least one payment card number, a phone number, an e-mail address, a preferred method of distribution, a name, etc. The processing server 106 may store the consumer information in a consumer data entry associated with the consumer 102 in a consumer database 112.

The processing server 106 may identify at least one offer included in an offer database 114, based on the identified geographic location of the financial transaction, discussed in more detail below. The processing server 106 may distribute the identified at least one offer to the consumer 102, such as by using a previously identified preferred method of distribution. Methods for distribution of offers, coupons, or discounts to a consumer will be apparent to persons having skill in the relevant art and may include e-mail, short message service (SMS) message, multimedia message service (MMS) message, and traditional mail. In some embodiments, methods of distribution may include social networks, such as posting an offer on the consumer's timeline on Facebook®, messaging an offer to the consumer 102 on Twitter®, etc. In some instances, the consumer 102 may access the offer distribution service via a mobile communication device, such as a smart phone. In such an instance, offers may be distributed via an application program executed by the mobile communication device and the consumer 102 may be notified by the application program (e.g., displaying a notification of a new offer) or by the mobile communication device itself (e.g., receiving a text or chat message indicating the availability of a new offer). In one embodiment, the application program may include chat functionality, and the consumer 102 may be notified of the new offer by the receipt of a chat message indicating the new offer.

### Processing Server

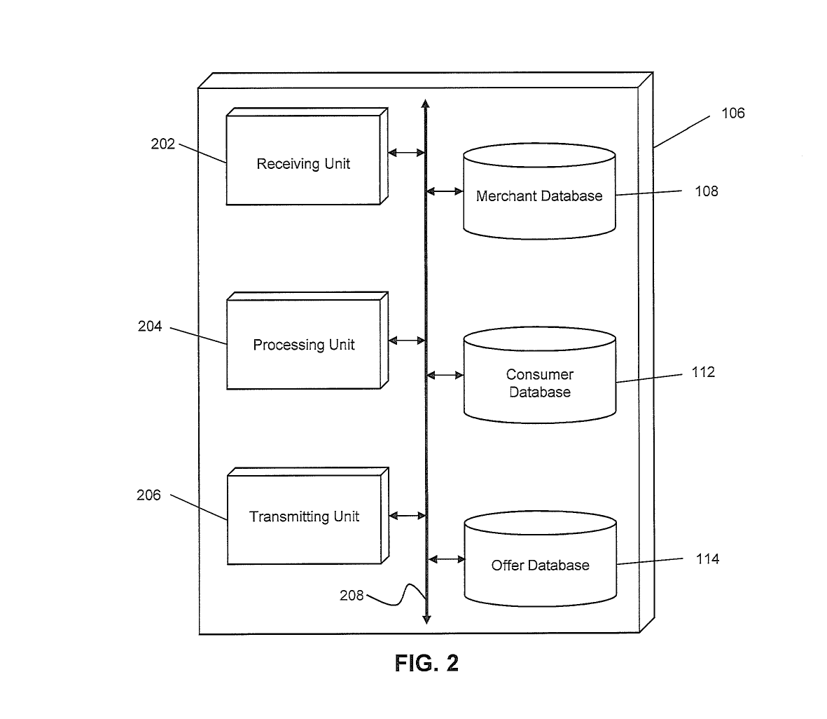

FIG. 2 illustrates an embodiment of the processing server 106 for use in the system 100. The processing server 106 may include at least a receiving unit 202, a processing unit 204, a transmitting unit 206, the merchant database 108, the consumer database 112, and the offer database 114. Each of the components may be configured to communicate via a bus 208. Suitable types and configurations of the bus 208 will be apparent to persons having skill in the relevant art.

The receiving unit 202 may be configured to receive consumer information from the consumer 102 for enrollment in an offer distribution service. The processing unit 204 may store the received consumer information in the consumer database 112. The consumer information may include at least a consumer identifier and a method of distribution. The consumer identifier may be any unique value used to identify the consumer 102, such as a phone number, an e-mail address, etc. In an exemplary embodiment, the consumer identifier may be a payment card number, such that the consumer 102 may be identified when using the associated payment card to fund the financial transaction. The method of distribution may be the method preferred by the consumer 102 for receiving an offer, such as e-mail, traditional mail, or MMS or SMS message.

The receiving unit 202 may be further configured to receive an authorization request for a financial transaction. In one embodiment, the authorization request may be formatted according to the ISO 8583 standard, as discussed herein. The processing unit 204 may be configured to process the authorization request using methods as will be apparent to persons having skill in the relevant art (e.g., communicating with an issuing bank that issued the payment card used in the transaction, etc.). The transmitting unit 206 may transmit an authorization response message to the merchant 104 based on the processing of the financial transaction (e.g., indicating approval or denial of the authorization request).

The processing unit 204 may be further configured to identify specific data elements in the authorization request. The processing unit 204 may identify a first data element that contains a merchant identifier. In one embodiment, the merchant identifier may be a merchant identification number (MID) or other value that may be specific to the point-of-sale terminal or store from which the authorization request originates. The processing unit 204 may identify, in the merchant database 108, a merchant data entry including the merchant identifier, which includes a geographic location, which may then be identified as the geographic location of the financial transaction.

In another embodiment, the merchant identifier may be a merchant name, and the processing unit 204 may further identify a second data element that contains a physical location. In some embodiments, the first and second data element may be a single data element that includes both the merchant name and a physical location, such as data element 43 in the ISO 8583 standard. The physical location may be a city and/or state, a postal code, a municipality, or other value that may indicate the physical location of where the transaction originated, but not the specific geographic location. In such an embodiment, the processing unit 204 may identify a number of merchant data entries in the merchant database 108 that include the same merchant identifier and physical locator. If the number of merchant data entries is one, then the geographic location of the one merchant data entry may be identified as the geographic location of the financial transaction. For example, the number of merchant data entries may be one when the merchant 104 may be the only store with that name (e.g., the only branch) in a particular city or physical location.

If the number of merchant data entries is greater than one, such as for a coffee shop franchise that may have multiple locations in a single city or area, the processing unit 204 may further identify another data element that may include a more detailed merchant identifier, such as one including an MID. The processing unit 204 may then identify a corresponding merchant data entry as discussed above, and identify the included geographic location. It will be apparent to persons having skill in the art that using a merchant name and physical location to identify a merchant prior to using a unique identifier may be beneficial, as the name and location may comprise less data than the unique identifier. As such, identifying the merchant data entry and subsequent geographic location may require less transfer and identification of data, which may result in faster or more efficient identification of merchants and geographic locations.

Once the geographic location of the financial transaction is identified, in one embodiment, the transmitting unit 206 may transmit the geographic location to the deal provider 110 for the providing of location-based services to the consumer 102. In another embodiment, the processing server 106 may utilize the geographic location for providing location-based services, such as offer distribution, to the consumer 102.

In such an embodiment, the processing unit 204 may identify a data element in the authorization request that includes consumer information, such as the payment card number for the payment card used to fund the transaction or other consumer identifier. The processing unit 204 may then identify a consumer data entry in the consumer database 112 corresponding to the consumer 102. The processing unit 204 may also identify at least one offer in the offer database 114 to be distributed to the consumer 102. Each offer in the offer database 114 may include at least a geographic location and a distribution distance. The identified at least one offer may be any offer where the included geographic location is within the distribution distance of the financial transaction based on the previously identified geographic location of the transaction.

It will be apparent to persons having skill in the relevant art that the distribution distance may vary based on the offer. It will further be apparent to persons having skill in the relevant art that each offer may include additional information relevant to the offer, such as an offer name, a merchant name, a manufacturer name, a unique identifier (e.g., a universal product code, etc.), a transaction modifier, a start date, an expiration date, a quantity, terms and conditions, an offer distributor, or limitations on redemption. The transmitting unit 206 may then distribute the identified at least one offer to the consumer 102, such as by the preferred method of distribution associated with the consumer 102 in the consumer database 112.

Data stored in the merchant database 108, the consumer database 112, and the offer database 114 (the “databases”) may be stored on any type of suitable computer readable media, such as optical storage (e.g., a compact disc, digital versatile disc, blu-ray disc, etc.) or magnetic tape storage (e.g., a hard disk drive). The databases may be configured in any type of suitable database configuration, such as a relational database, a structured query language (SQL) database, a distributed database, an object database, etc. Suitable configurations and database storage types will be apparent to persons having skill in the relevant art. The databases may each be a single database, or may comprise multiple databases which may be interfaced together (e.g., physically or via a network, such as the network 118).

### Merchant Database

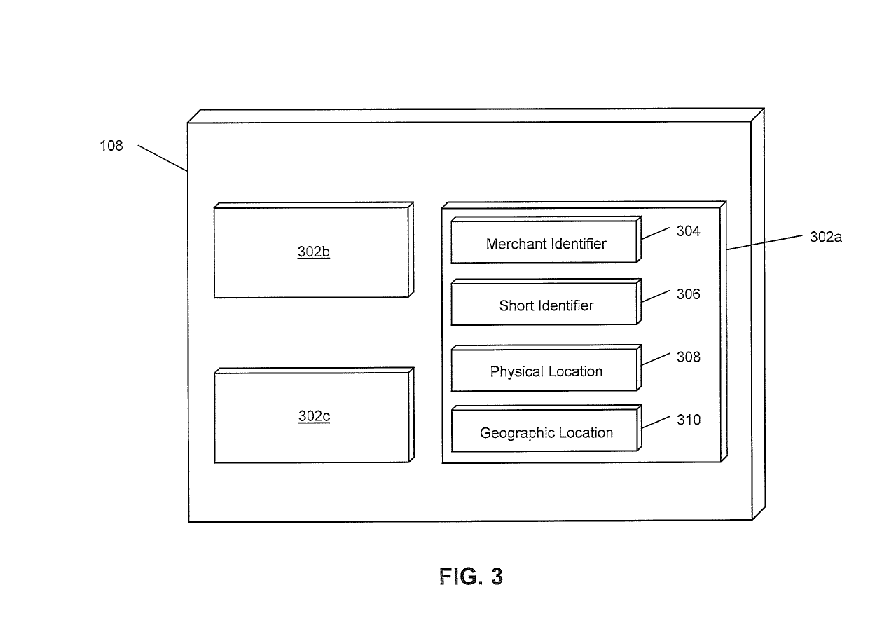

FIG. 3 illustrates an embodiment of the merchant database 108, which may be included in the processing server 106 of the system 100. The merchant database 108 may include a plurality of merchant data entries 302, illustrated in FIG. 3 merchant data entries 302a, 302b, and 302c. Each merchant data entry 302 may include at least a merchant identifier 304 and a geographic location 310. In some embodiments, each merchant data entry 302 may further include a short identifier 306 and a physical location 308.

The merchant identifier 304 may be a unique value associated with a merchant (e.g., the merchant 104) for identifying the corresponding merchant data entry 302 as associated with the merchant. Values suitable for use as the merchant identifier 304 will be apparent to persons having skill in the relevant art and may include a merchant identification number (MID), a serial number, a network address, a unique address assigned to a point-of-sale terminal device (e.g., a MAC address), etc. In some embodiments, the merchant identifier 304 may be unique to a particular merchant location (e.g., a specific brick and mortar store). In other embodiments, the merchant identifier 304 may be unique to a point-of-sale terminal such that multiple merchant data entries 302 may correspond to the same merchant 104 location.

The geographic location 310 may be the location of the corresponding merchant 104 represented in a geographic form suitable for the use of location-based services. In an exemplary embodiment, the geographic location 310 may be represented by latitude and longitude. In other embodiments, the geographic location 310 may be a street address or other type of geolocation suitable for performing the functions as disclosed herein.

The short identifier 306 may be a value suitable for identifying the merchant 104 as associated with the merchant data entry 302, but may not be unique to a specific merchant location or point-of-sale system. In some instances, the short identifier 306 may be a smaller value in terms of data, such that the identification and transmission of the short identifier 306 may require less bandwidth and/or may be faster. In an exemplary embodiment, the short identifier 306 may be the merchant name.

The physical location 308 may be a physical descriptor of the location of the corresponding merchant 104 of the merchant data entry 302. In some embodiments, the physical location 308 may be used along with the short identifier 306 to identify a specific merchant data entry 302 without the identification or use of the merchant identifier 304. In such an instance, the processing server 106 may be able to identify the geographic location 310 of a financial transaction faster and/or more efficiently (e.g., with less transfer of data) than using the merchant identifier 304. In one embodiment, the physical location 308 may be one of: a city and state, a postal code, a municipality, and an address

It will be apparent to persons having skill in the relevant art that, in some instances, multiple merchant data entries 302 may include the same value for the short identifier 306 and the physical location 308, such as if there are multiple locations of a merchant in a single city or area. In such an instance, the processing sever 106 may then identify a data element in an authorization request that includes a merchant identifier, for comparison to the merchant identifier 304 for each of the multiple merchant data entries 302. In other instances, a single merchant data entry 302 may have a unique combination of short identifier 306 and physical location 308, which may enable the processing server 106 to identify the geographic location 310 of the financial transaction without further identification of a merchant identifier 304.

### Geolocation of a Financial Transaction and Distribution of Location-Based Offers

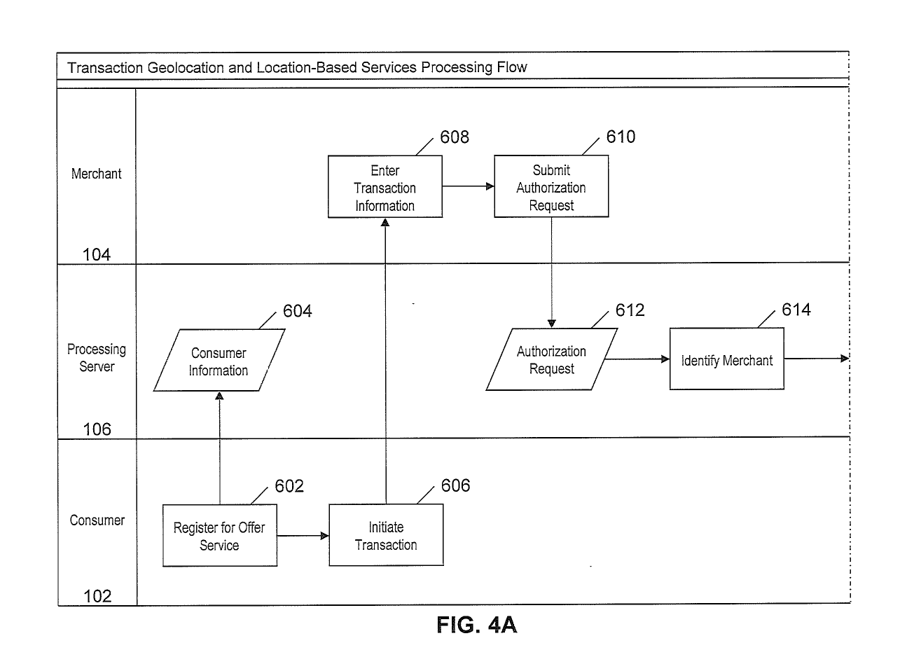

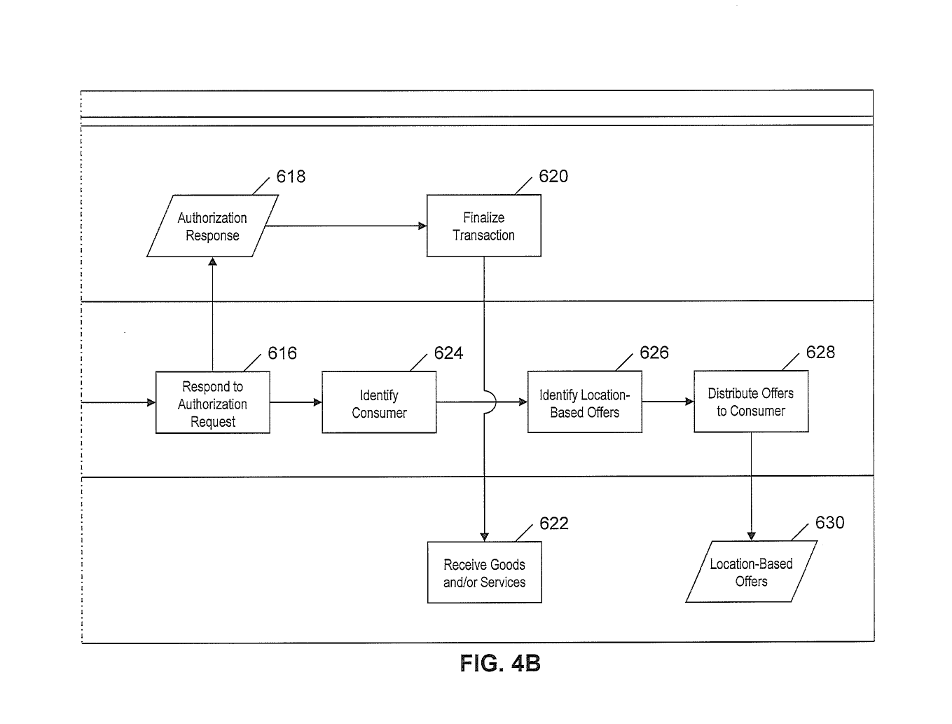

FIGS. 4A and 4B illustrate a processing flow for the geolocation of a financial transaction and the distribution of offers based on the identified location.

In step 602, the consumer 102 may register for an offer service with the processing server 106. Registration of an offer service (e.g., a service for the distribution of offers, coupons, discounts, etc.) may include the consumer 102 providing consumer information, such as name, e-mail address, phone number, payment account information, preferred distribution method, etc. In step 604, the processing server 106 may receive the consumer information, which may be stored in the consumer database 112.

In step 606, the consumer 102 may initiate a financial transaction with the merchant 104 for the purchase of products (e.g., goods or services). In step 608, the merchant 104 may enter transaction information for the financial transaction (e.g., by scanning or inputting the requested products) into a point-of-sale terminal. The transaction information may include, for example, a transaction amount and funding information for funding the transaction, such as a payment card number furnished by the consumer 102. In step 610, the merchant 104 (e.g., or an acquirer on behalf of the merchant 104) may submit an authorization request for the financial transaction to the processing server 106. In an exemplary embodiment, the authorization request may be formatted pursuant to the ISO 8583 standard.

In step 614, the processing server 106 may identify the merchant 104 by identifying a merchant data entry 302 in the merchant database 108 associated with the merchant 104. In one embodiment, identification of the merchant data entry 302 may include identifying a data element in the authorization request including a merchant identifier 304 and identifying the merchant data entry 302 in the merchant database 108 including the same merchant identifier 304.

In another embodiment, identification of the merchant data entry 302 may include identifying a first data element including a short identifier 306 and a second data element including a physical location 308, and then identifying the number of corresponding merchant data entries 302. If only a single merchant data entry 302 includes the short identifier 306 and physical location 308, then that single merchant data entry 302 corresponds to the merchant 104. If multiple merchant data entries 302 include the identified information, then a third data element including the merchant identifier 304 may be identified in order to identify the correct merchant data entry 302. In some embodiments, the physical location 308 included in the second data element may need to be reformatted by the processing server 106 prior to identification. For example, the second data element may include a physical location of “5th Street” for a financial transaction, whereas the actual street address is represented as “Fifth Street,” such as if data is being conserved in the authorization request.

In step 616, the processing server 106 may process the financial transaction transmit a response to the authorization request to the merchant 104 or an acquirer acting on behalf of the merchant 104. Methods for processing the financial transaction will be apparent to persons having skill in the relevant art, and may include identifying an issuer having issued the payment card used in the financial transaction, and requesting approval of the transaction based on the transaction amount. In step 618, the merchant 104 may receive the authorization response, which may indicate if the financial transaction is approved or denied. In step 620, the merchant 104 may finalized the transaction based on the authorization response. For example, if the transaction is approved, then, in step 622, the transacted for products may be provided to the consumer 102.

In step 624, the processing server 106 may identify the consumer in the financial transaction. Identification of the consumer may include identifying a data element in the financial transaction including a consumer identifier, and then identifying a corresponding consumer data entry in the consumer database 112 including that consumer identifier. For example, the consumer identifier may be a payment card number used to fund the financial transaction.

In step 626, the processing server 106 may identify location-based offers to distribute to the consumer 102 based on the geographic location of the financial transaction. Identification of offers may include identifying any offers in the offer database 114 where the geographic location 310 of the identified merchant data entry 302 may be within a distribution distance of the geographic location included in the offer. It will be apparent to persons having skill in the art that the distribution of offers to the consumer 102 may also be based on additional criteria. For example, offer distribution may be further based on consumer preferences, distributor preferences, transaction amount, merchant category, merchant industry, time and/or date, offer quantity, consumer conversion rate, etc. Additional criteria and considerations for the distribution of offers to consumers based on location may be found in U.S. patent application Ser. No. 13/293,870, entitled “Method and Apparatus for Distributing Advertisements Using Social networks and Financial Transaction Card Networks” to Peter D. Kaulbach, filed on Nov. 10, 2011, which is herein incorporated by reference in its entirety.

In step 628, the processing server 106 may distribute the identified offer or offers to the consumer 102, such as by using the consumer's preferred method of distribution as including in the consumer information received in step 604 and stored in the consumer database 112. For example, the offer or offers may distributed by e-mail, traditional mail, SMS message, MMS message, at least one social network, and an application program. In one embodiment, a distributed offer may be encoded, such as in a bar code (e.g., a QR code) or be presented to the consumer 102 in an application program (e.g., executed on a communication device, such as a laptop or a smart phone). In step 630, the consumer 102 may receive the location-based offers for use in future financial transactions.

It will be apparent to persons having skill in the relevant art that, in some embodiments, steps 602, 604, and 624-630 may be optional. In such embodiments, the processing server 106 may identify the geographic location 310 of the financial transaction and may then transmit the identified geographic location 310 to a third party, which may be used to provide location-based services to the consumer 102. For example, the third party may be the deal provider 110 (e.g., for providing location-based offers to the consumer 102). In one embodiment, the geographic location 310 may be transmitted to the consumer 102, such as for personal records, tax purposes, etc.

In one embodiment, the processing server 106 may transmit the identified geographic location 310 to an advertising agency, such as for the advertising of location-based offers to the consumer 102. The advertising agency or other third party may also place the consumer 102 in a targeted group (e.g., a micro segment, audience, etc.) of a plurality of consumers involved in financial transactions in proximity of one another, for the sake of, for example, targeted advertising offers or services. In such an embodiment, the geographic location 310 of the transaction may also be combined with other information (e.g., demographic information) while still maintaining anonymity of the consumer 102. Systems and methods for the protection of privacy for targeted audiences of consumers are disclosed in U.S. patent application Ser. No. 13/437,987, entitled “Protecting Privacy in Audience Creation” by Curtis Villars, filed on Apr. 3, 2012, which is herein incorporated by reference in its entirety.

In some instances, the processing server 106 may format the geographic location 310 prior to transmission to a third party. For example, a third party may request street addresses as a preferred form of geographic location, which may result in the processing server 106 identifying the corresponding street address for a latitude and longitude represented geographic location 310. Other manners of transmission or third parties that may receive benefit from the geographic location 310 of the financial transaction will be apparent to persons having skill in the relevant art.

### Computer System Architecture

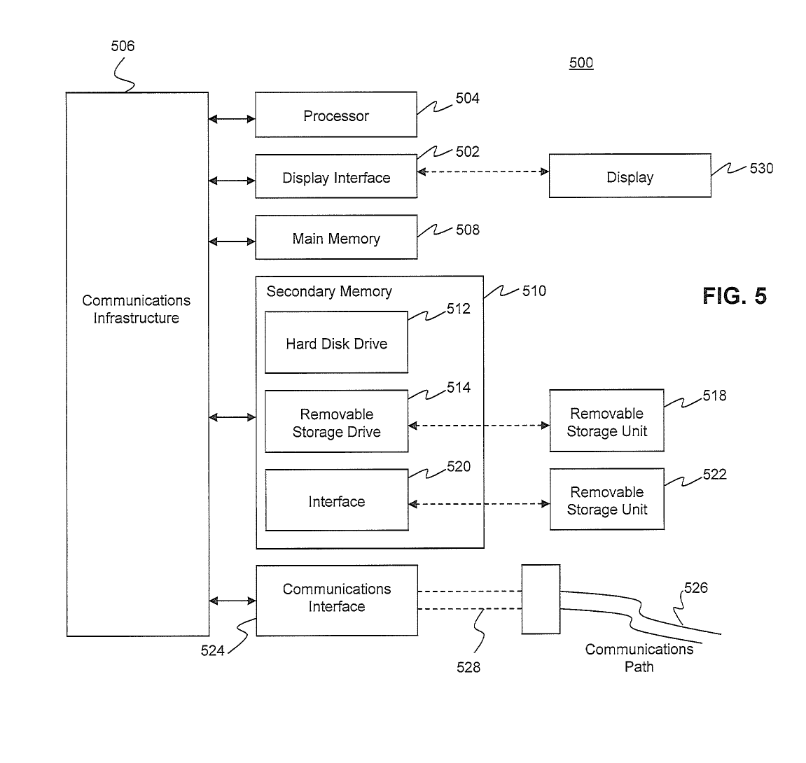

FIG. 5 illustrates a computer system 500 in which embodiments of the present disclosure, or portions thereof, may be implemented as computer-readable code. For example, the merchant 104 and the processing server 106 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4A, 4B, 6, and 7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communication infrastructure 506, such as a bus, message queue, network (e.g., the network 118), multi-core message-passing scheme, etc. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive, the removable storage unit 518 may be a floppy disk. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

Computer program medium and computer usable medium may refer to memories, such as the main memory 508 and secondary memory 510, which may be memory semiconductors (e.g. DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 804 to implement the methods illustrated by FIGS. FIGS. 4A, 4B, 6, and 7, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

### First Exemplary Method for Identifying a Geographic Location of a Financial Transaction

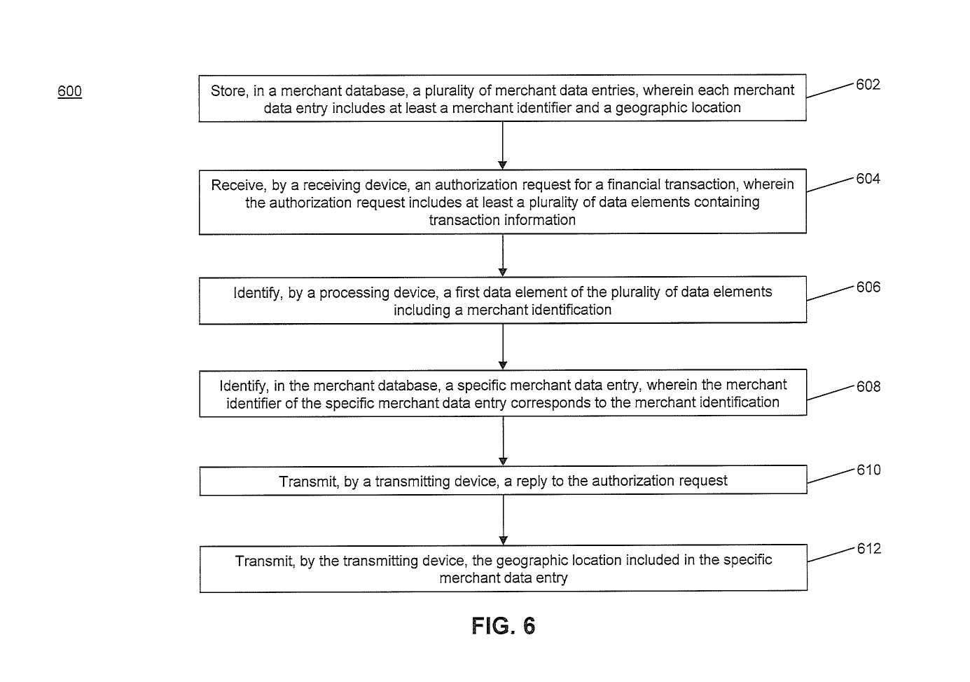

FIG. 6 illustrates a method 600 for identifying a geographic location of a financial transaction.

In step 602, a plurality of merchant data entries (e.g., the merchant data entries 302) may be stored in a merchant database (e.g., the merchant database 108), wherein each merchant data entry 302 includes at least a merchant identifier (e.g., the merchant identifier 304) and a geographic location (e.g., the geographic location 310). In one embodiment, the merchant identifier 304 may be one of: a merchant identification number (MID), a physical address, and a serial number. In one embodiment, the geographic location 310 may be represented by latitude and longitude.

In step 604, a receiving device (e.g., the receiving unit 202), may receive an authorization request for a financial transaction, wherein the authorization request includes at least a plurality of data elements containing transaction information. In one embodiment, the authorization request may be formatted pursuant to the ISO 8583 standard. In step 606, a processing device (e.g., the processing device 204) may identify a first data element of the plurality of data elements including a merchant identification.

In step 608, a specific merchant data entry 302 in the merchant database 108 may be identified, wherein the merchant identifier 304 of the specific merchant data entry 302 corresponds to the merchant identification. In step 610, a transmitting device (e.g., the transmitting unit 206) may transmit a reply to the authorization request. In step 612, the transmitting device 206 may transmit the geographic location 310 included in the specific merchant data entry 302. In one embodiment, the reply to the authorization request may include the geographic location 310. In some embodiments, the geographic location 310 included in the specific merchant data entry 302 may be transmitted to a third party, such as an offer provider (e.g., the deal provider 110).

In one embodiment, the method 600 may further include storing, in an offer database (e.g., the offer database 114), a plurality of offers, wherein each offer includes at least a distribution location and a distribution distance, and storing, in a consumer database (e.g., the consumer database 112), a plurality of consumer data entries, wherein each consumer data entry is associated with a consumer (e.g., the consumer 102) and includes at least a consumer identifier and a method of distribution. The processing device 204 may identify a second data element in the plurality of data elements including a consumer identification, and identify, in the consumer database 112, a specific consumer data entry where the included consumer identifier corresponds to the consumer identification. The processing device 204 may further identify, in the offer database 114, at least one offer where the included distribution location is within the distribution distance of the geographic location 310 included in the specific merchant data entry 302. The transmitting device 206 may then distribute, by the method of distribution included in the specific consumer data entry, the identified at least one offer to the consumer 102 associated with the specific consumer data entry.

In a further embodiment, each of the plurality of offers may include at least one of: a distributor, an offer name, an offer description, a quantity, an expiration date, a transaction modifier, terms and conditions, and a limitation on redemption. In another further embodiment, the consumer identifier may be a payment account. In yet another further embodiment, the method of distribution may be at least one of: electronic mail, traditional mail, short message service (SMS) message, multimedia message service (MMS) message, at least one social network, and an application program.

### Second Exemplary Method for Identifying a Geographic Location of a Financial Transaction

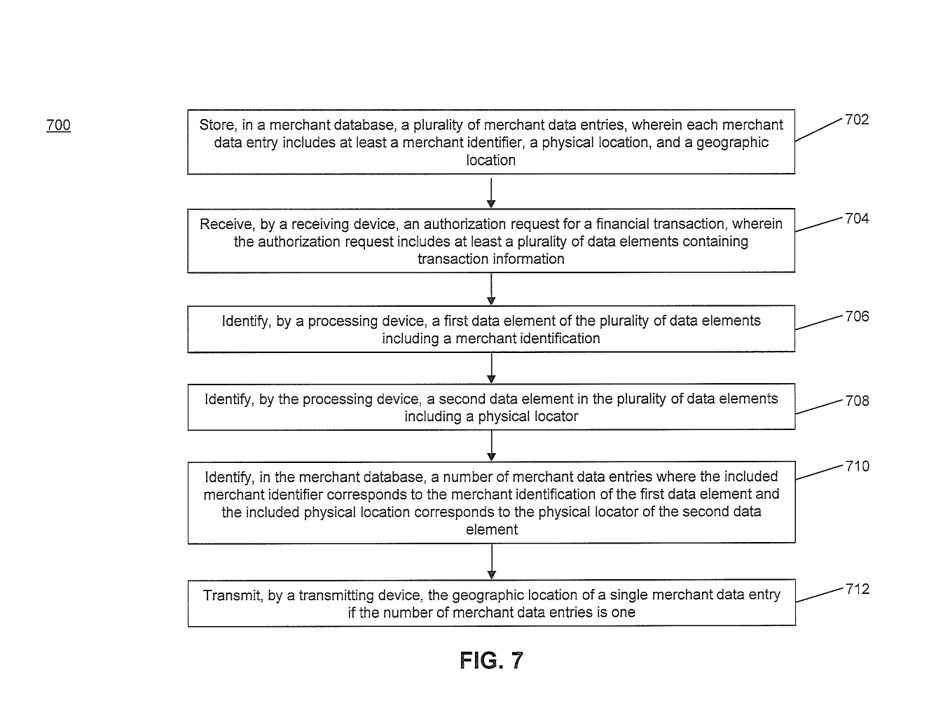

FIG. 7 illustrates a method 700 for identifying a geographic location for a financial transaction.

In step 702, a plurality of merchant data entries (e.g., merchant data entries 302) may be stored in a merchant database (e.g., the merchant database 108), wherein each merchant data entry 302 includes at least a merchant identifier (e.g., the short identifier 306), a physical location (e.g., the physical location 308), and a geographic location (e.g., the geographic location 310). In one embodiment, the geographic location 310 may be represented by latitude and longitude. In one embodiment, the physical location 308 may be one of: a city and state, a postal code, a municipality, and a street address. In some embodiments, the merchant identifier 306 may be one of: a merchant name, a merchant identification number (MID), and a merchant trade name.

In step 704, an authorization request for a financial transaction may be received by a receiving device (e.g., the receiving unit 202), wherein the authorization request includes at least a plurality of data elements containing transaction information. In one embodiment, the authorization request may be formatted pursuant to the ISO 8583 standard. In step 706, a processing device (e.g., the processing unit 204) may identify a first data element of the plurality of data elements including a merchant identification. In step 708, the processing device 204 may identify a second data element of the plurality of data elements including a physical locator. In one embodiment, the first and second data elements may be a single data element. In a further embodiment, the single data element may be data element 43.

In step 710, a number of merchant data entries where the included merchant identifier 306 corresponds to the merchant identification of the first data element and the included physical location 308 corresponds to the physical locator of the second data element may be identified in the merchant database 108. In step 712, a transmitting device (e.g., the transmitting unit 206) may transmit the geographic location 310 of a single merchant data entry 302 if the number of merchant data entries is one. In one embodiment, the geographic location 310 of the single merchant data entry 302 may be transmitted to a third party, such as an offer provider (e.g., the deal provider 110).

In some embodiments, each merchant data entry 302 may further including an identifying value (e.g., the merchant identifier 304) and the method 700 may further include identifying, if the number of merchant data entries is greater than one, a third data element in the plurality of data elements including an identification value; identifying, in the merchant database 108, a specific merchant data entry 302 where the included identifying value 304 corresponds to the identification value of the third data element; and transmitting, by the transmitting device 206, the geographic location 310 of the specific merchant data entry.

In one embodiment, the method 700 may further include storing, in an offer database (e.g., the offer database 114), a plurality of offers, wherein each offer includes at least a distribution location and a distribution distance, and storing, in a consumer database (e.g., the consumer database 112), a plurality of consumer data entries, wherein each consumer data entry is associated with a consumer (e.g., the consumer 102) and includes at least a consumer identifier and a method of distribution. The processing device 204 may identify a second data element in the plurality of data elements including a consumer identification, and identify, in the consumer database 112, a specific consumer data entry where the included consumer identifier corresponds to the consumer identification. The processing device 204 may further identify, in the offer database 114, at least one offer where the included distribution location is within the distribution distance of the geographic location 310 included in the specific merchant data entry 302. The transmitting device 206 may then distribute, by the method of distribution included in the specific consumer data entry, the identified at least one offer to the consumer 102 associated with the specific consumer data entry.

In a further embodiment, each of the plurality of offers may include at least one of: a distributor, an offer name, an offer description, a quantity, an expiration date, a transaction modifier, terms and conditions, and a limitation on redemption. In another further embodiment, the consumer identifier may be a payment account. In yet another further embodiment, the method of distribution may be at least one of: electronic mail, traditional mail, short message service (SMS) message, multimedia message service (MMS) message, at least one social network, and an application program.

Techniques consistent with the present disclosure provide, among other features, systems and methods for identifying a geographic location of a financial transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a geographic location of a financial transaction, comprising:
storing, in a merchant database, a plurality of merchant data entries, wherein each merchant data entry includes at least a merchant identifier and a geographic location;
receiving, by a receiving device, an authorization request for a financial transaction, wherein the authorization request includes at least a plurality of data elements containing transaction information;
identifying, by a processing device, a first data element in the plurality of data elements including a merchant identification;
identifying, in the merchant database, a specific merchant data entry, wherein the merchant identifier of the specific merchant data entry corresponds to the merchant identification;
transmitting, by a transmitting device, a reply to the authorization request; and
transmitting, by the transmitting device, the geographic location included in the specific merchant data entry.

2. The method of claim 1, further comprising:
storing, in an offer database, a plurality of offers, wherein each offer includes at least a distribution location and a distribution distance;
storing, in a consumer database, a plurality of consumer data entries, wherein each consumer data entry is associated with a consumer and includes at least a consumer identifier and a method of distribution;
identifying, by the processing device, a second data element in the plurality of data elements including a consumer identification;
identifying, in the consumer database, a specific consumer data entry where the included consumer identifier corresponds to the consumer identification;
identifying, in the offer database, at least one offer where the included distribution location is within the distribution distance of the geographic location included in the specific merchant data entry; and
distributing, by the method of distribution included in the specific consumer data entry, the identified at least one offer to the consumer associated with the specific consumer data entry.

3. The method of claim 2, wherein each offer of the plurality of offers further includes at least one of: a distributor, an offer name, an offer description, a quantity, an expiration date, a transaction modifier, terms and conditions, and a limitation on redemption.

4. The method of claim 2, wherein the consumer identifier is a payment account.

5. The method of claim 2, wherein the method of distribution is at least one of: electronic mail, traditional mail, short message service (SMS) message, multimedia message service (MMS) message, at least one social network, and an application program.

6. The method of claim 1, wherein the geographic location included in the specific merchant data entry is transmitted to an offer provider.

7. The method of claim 1, wherein the reply to the authorization request includes the geographic location in the specific merchant data entry.

8. The method of claim 1, wherein the geographic location is represented by latitude and longitude.

9. The method of claim 1, wherein the merchant identifier is one of: a merchant identification number (MID), a physical address, and a serial number.

10. A method for identifying a geographic location of a financial transaction, comprising:
storing, in a merchant database, a plurality of merchant data entries, wherein each merchant data entry includes at least a merchant identifier, a physical location, and a geographic location;
receiving, by a receiving device, an authorization request for a financial transaction, wherein the authorization request includes a plurality of data elements containing transaction information;
identifying, by a processing device, a first data element in the plurality of data elements including a merchant identification;
identifying, by the processing device, a second data element in the plurality of data elements including a physical locator;
identifying, in the merchant database, a number of merchant data entries where the included merchant identifier corresponds to the merchant identification of the first data element and the included physical location corresponds to the physical locator of the second data element; and
transmitting, by a transmitting device, the geographic location of a single merchant data entry if the number of merchant data entries is one.

11. The method of claim 10, wherein each merchant data entry further includes an identifying value, and the method further comprising:
identifying, if the number of merchant data entries is greater than one, a third data element in the plurality of data elements including an identification value;
identifying, in the merchant database, a specific merchant data entry where the included identifying value corresponds to the identification value of the third data element; and
transmitting, by the transmitting device, the geographic location of the specific merchant data entry.

12. The method of claim 10, further comprising:
storing, in an offer database, a plurality of offers, wherein each offer includes at least a distribution location and a distribution distance;
storing, in a consumer database, a plurality of consumer data entries, wherein each consumer data entry is associated with a consumer and includes at least a consumer identifier and a method of distribution;
identifying, by the processing device, a third data element in the plurality of data elements including a consumer identification;
identifying, in the consumer database, a specific consumer data entry where the included consumer identifier corresponds to the consumer identification;
identifying, in the offer database, at least one offer where the included distribution location is within the distribution distance of the geographic location included in the single merchant data entry; and
distributing, by the method of distribution included in the specific consumer data entry, the identified at least one offer to the consumer associated with the specific consumer data entry.

13. The method of claim 12, wherein each offer of the plurality of offers further includes at least one of: a distributor, an offer name, an offer description, a quantity, an expiration date, a transaction modifier, terms and conditions, and a limitation on redemption.

14. The method of claim 12, wherein the consumer identifier is a payment account.

15. The method of claim 12, wherein the method of distribution is at least one of: electronic mail, traditional mail, short message service (SMS) message, multimedia message service (MMS) message, at least one social network, and an application program.

16. The method of claim 10, wherein the geographic location included in the single merchant data entry is transmitted to an offer provider.

17. The method of claim 10, wherein the first data element and the second data element are a single data element.

18. The method of claim 10, wherein the geographic location is represented by latitude and longitude.

19. The method of claim 10, wherein the physical location is one of: a city and state, a postal code, a municipality, and a street address.

20. The method of claim 10, wherein the merchant identifier is one of: a merchant name, a merchant identification number (MID), and a merchant trade name.

21. A system for identifying a geographic location of a financial transaction, comprising:
a merchant database configured to store a plurality of merchant data entries, wherein each merchant data entry includes at least a merchant identifier and a geographic location;
a receiving device configured to receive an authorization request for a financial transaction, wherein the authorization request includes at least a plurality of data elements containing transaction information;
a processing device configured to
identify a first data element in the plurality of data elements including a merchant identification, and
identify, in the merchant database, a specific merchant data entry, wherein the merchant identifier of the specific merchant data entry corresponds to the merchant identification; and
a transmitting device configured to
transmit a reply to the authorization request, and
transmit the geographic location included in the specific merchant data entry.

22. The system of claim 21, further comprising:
an offer database configured to store a plurality of offers, wherein each offer includes at least a distribution location and a distribution distance; and
a consumer database configured to store a plurality of consumer data entries, wherein each consumer data entry is associated with a consumer and includes at least a consumer identifier and a method of distribution, wherein
the processing device is further configured to
identify a second data element in the plurality of data elements including a consumer identification,
identify, in the consumer database, a specific consumer data entry where the included consumer identifier corresponds to the consumer identification, and
identify, in the offer database, at least one offer where the included distribution location is within the distribution distance of the geographic location included in the specific merchant data entry, and
the transmitting device is further configured to distribute, by the method of distribution included in the specific consumer data entry, the identified at least one offer to the consumer associated with the specific consumer data entry.

23. The system of claim 22, wherein each offer of the plurality of offers further includes at least one of: a distributor, an offer name, an offer description, a quantity, an expiration date, a transaction modifier, terms and conditions, and a limitation on redemption.

24. The system of claim 22, wherein the consumer identifier is a payment account.

25. The system of claim 22, wherein the method of distribution is at least one of: electronic mail, traditional mail, short message service (SMS) message, multimedia message service (MMS) message, at least one social network, and an application program.

26. The system of claim 21, wherein the geographic location included in the specific merchant data entry is transmitted to an offer provider.

27. The system of claim 21, wherein the reply to the authorization request includes the geographic location in the specific merchant data entry.

28. The system of claim 21, wherein the geographic location is represented by latitude and longitude.

29. The system of claim 21, wherein the merchant identifier is one of: a merchant identification number (MID), a physical address, and a serial number.

30. A system for identifying a geographic location of a financial transaction, comprising:
a merchant database configured to store a plurality of merchant data entries, wherein each merchant data entry includes at least a merchant identifier, a physical location, and a geographic location;
a receiving device configured to receive an authorization request for a financial transaction, wherein the authorization request includes a plurality of data elements containing transaction information;
a processing device configured to
identify a first data element in the plurality of data elements including a merchant identification,
identify a second data element in the plurality of data elements including a physical locator, and
identify, in the merchant database, a number of merchant data entries where the included merchant identifier corresponds to the merchant identification of the first data element and the included physical location corresponds to the physical locator of the second data element; and
a transmitting device configured to transmit the geographic location of a single merchant data entry if the number of merchant data entries is one.

31. The system of claim 30, wherein
each merchant data entry further includes an identifying value;
the processing device is further configured to
identify, if the number of merchant data entries is greater than one, a third data element in the plurality of data elements including an identification value, and
identify, in the merchant database, a specific merchant data entry where the included identifying value corresponds to the identification value of the third data element; and
the transmitting device is further configured to transmit the geographic location of the specific merchant data entry.

32. The system of claim 30, further comprising:
an offer database configured to store a plurality of offers, wherein each offer includes at least a distribution location and a distribution distance; and
a consumer database configured to store a plurality of consumer data entries, wherein each consumer data entry is associated with a consumer and includes at least a consumer identifier and a method of distribution, wherein
the processing device is further configured to
identify a third data element in the plurality of data elements including a consumer identification,
identify, in the consumer database, a specific consumer data entry where the included consumer identifier corresponds to the consumer identification, and
identify, in the offer database, at least one offer where the included distribution location is within the distribution distance of the geographic location included in the single merchant data entry, and
the transmitting device is further configured to distribute, by the method of distribution included in the specific consumer data entry, the identified at least one offer to the consumer associated with the specific consumer data entry.

33. The system of claim 32, wherein each offer of the plurality of offers further includes at least one of: a distributor, an offer name, an offer description, a quantity, an expiration date, a transaction modifier, terms and conditions, and a limitation on redemption.

34. The system of claim 32, wherein the consumer identifier is a payment account.

35. The system of claim 32, wherein the method of distribution is at least one of: electronic mail, traditional mail, short message service (SMS) message, multimedia message service (MMS) message, at least one social network, and an application program.

36. The system of claim 30, wherein the geographic location included in the single merchant data entry is transmitted to an offer provider.

37. The system of claim 30, wherein the first data element and the second data element are a single data element.

38. The system of claim 30, wherein the geographic location is represented by latitude and longitude.

39. The system of claim 30, wherein the physical location is one of: a city and state, a postal code, a municipality, and a street address.

40. The system of claim 30, wherein the merchant identifier is one of: a merchant name, a merchant identification number (MID), and a merchant trade name.
